(19) United States
(12) Patent Application Publication
(10) Pub. No.: US 2020/0095922 A1
(43) Pub. Date: Mar. 26, 2020

(54) DIESEL PISTON WITH RADIAL LIPS IN LOWER BOWL

(71) Applicant: GM GLOBAL TECHNOLOGY OPERATIONS LLC, DETROIT, MI (US)

(72) Inventors: Alberto Lorenzo Vassallo, Torino (IT); Francesco Concetto Pesce, Torino (IT); Andrea Tripodi, Genova (IT)

(21) Appl. No.: 16/139,330

(22) Filed: Sep. 24, 2018

(51) Int. Cl. F02B 23/06

(52) U.S. Cl. CPC F02B 23/0672

(57) ABSTRACT

A piston for a diesel engine includes a piston body having a skirt and crown. The piston body has portions defining an outer combustion bowl and an inner combustion bowl within the piston body through the crown. The outer combustion bowl has an upper annular side wall extending from the crown surface and an annular flat shelf extending from the upper annular side wall. The inner combustion bowl is recessed with respect to the annular flat shelf of the outer combustion bowl. The inner combustion bowl has a curved annular side wall and a plurality of protruding lips extending from the curved annular side wall toward a central axis of the piston body.

### FIELD

The present disclosure relates to a diesel piston having an outer combustion bowl and an inner combustion bowl for improved emissions, reduced fuel consumption, and higher power output.

### INTRODUCTION

Diesel emissions are heavily regulated by federal governments. Accordingly, diesel systems designers have developed several improvements in diesel systems to reduce emissions. For example, enhanced air system designs provide higher rates of cooled EGR (exhaust gas recirculation), thereby reducing NOₓ emissions, and enhanced fuel injection systems reduce the inevitably higher soot emissions that would result from the use of higher EGR rates. Also, combined soot and NOₓ emissions after-treatment systems reduce emissions from diesel engines. Exhaust after treatment systems, however, can be costly.

In addition, soot resulting from combustion may be deposited on portions of the combustion chamber and may transfer to the engine oil system, thereby contaminating the oil. Exhaust after-treatment systems do nothing to stop the transfer of soot into the engine oil, as it occurs upstream of the exhaust after-treatment system.

### SUMMARY

The present disclosure provides an improved diesel engine combustion bowl design that allows for enhanced mixing of combustion products with excess air available in the cylinder, simultaneously reducing soot and NOₓ emissions. In addition, at low loads, heat losses are reduced, while at high loads, over-rich combustion is reduced by virtue of separators in the lower bowl. More particularly, the present disclosure provides a piston having an improved stepped bowl design with separators disposed in the lower bowl. The new stepped bowl design integrates a bottom profile with smoothly varying curvature and a sharp step at the top. The novel piston generates robust turbulent vortices due to spray-bowl interaction, which enhances in-cylinder air fuel mixing, resulting in faster combustion, lower emissions, and extremely low levels of soot contamination in the engine oil.

In some forms, the lower (or inner) bowl has a re-entrant, compact shape with smoothly varying curvature for improving mixing and low heat rejection at low loads, and separators that cause avoidance of over-rich combustion at high loads. The upper (or outer) bowl may have flat and sharp-step surfaces for enhanced mixing and efficient air utilization and minimal liner-soot contact at high loads.

In one form, which may be combined with or separate from the other forms disclosed herein, a piston for a diesel engine is provided that includes a piston body having a skirt extending from a proximal end of the piston body and a crown disposed at a distal end of the piston body. The crown defines a crown surface. The piston body has portions defining an outer combustion bowl and an inner combustion bowl within the piston body through the crown. The outer combustion bowl has an upper annular side wall extending from the crown surface and an annular flat shelf extending from the upper annular side wall. The inner combustion bowl is recessed with respect to the annular flat shelf of the outer combustion bowl. The inner combustion bowl has a curved annular side wall and a plurality of protruding lips extending from the curved annular side wall toward a central axis of the piston body.

Additional features may optionally be provided, including but not limited to the following: each protruding lip of the plurality of protruding lips being equally spaced about the central axis; each protruding lip having a height between 2.5 and 5.5 millimeters, wherein each protruding lip extends along its height from the curved annular side wall of the inner combustion bowl; wherein the plurality of protruding lips includes at least seven protruding lips and fewer than eleven protruding lips; each protruding lip intersecting the curved annular side wall at a fillet; each fillet having a fillet radius in the range of 0.75 to 3.25 millimeters; each protruding lip having a pair of lip side walls extending from the curved annular side wall; each pair of lip side walls defining an angle therebetween, the angle being ten degrees or less.

Further additional features may be provided, including but not limited to the following: the annular flat shelf being recessed a longitudinal distance in the range of 2.5 to 4.5 millimeters from a plane coplanar with the crown surface, the longitudinal distance being measured along a first line parallel to the central axis; the piston body defining an inner convex curved surface connecting the annular flat shelf of the outer combustion bowl to the curved annular side wall of the inner combustion bowl; the inner convex curved surface having a radius of curvature in the range of 1 to 2 millimeters; a first radial distance between the annular flat shelf and the crown surface being in the range of 1.5 to 2 millimeters, the first radial distance being measured along a first line perpendicular to the central axis; a radius of curvature between the upper annular side wall and the annular flat shelf being the range of 0.25 to 0.75 millimeter; the inner combustion bowl having a lowest point that is 12 to 14 millimeters from the plane coplanar with the crown surface along a second line parallel to the central axis; and the inner combustion bowl having a radially outermost point that is 24 to 27 millimeters from the central axis along a second line perpendicular to the central axis.

Still further additional features may be provided, including: a center of the inner combustion bowl being disposed 5 to 7 millimeters along the central axis from the plane coplanar with the crown surface, the center being located along the central axis of the piston body; a radially innermost point of the inner convex curved surface being disposed 23 to 25 millimeters from the central axis along a third line perpendicular to the central axis; the radially innermost point of the inner convex curved surface being disposed radially inward of the radially outermost point of the inner combustion bowl by a second radial distance of 1 to 2 millimeters, the second radial distance being measured along a fourth line perpendicular to the central axis; the piston body defining an outer convex curved surface connecting the upper annular side wall to the crown surface; the outer convex curved surface being disposed a distance of 8 to 10 millimeters from an outer edge of the crown along a fifth line perpendicular to the central axis; the annular flat shelf having a radial length extending from the upper annular side wall to the inner convex curved surface, the radial length being 7 to 8 millimeters; the upper annular side wall extending from the crown surface at an angle between 100 and 110 degrees; the crown surface defining a plurality of radially outwardly extending reliefs formed through the crown surface; and each relief being defined by a pair of relief side walls that narrow the reliefs as the reliefs extend radially outward.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only and are not intended to limit the scope of the present disclosure or the claims.

FIG. 1 is a cross-sectional view of a piston within a cylinder bore of an engine, in accordance with the principles of the present disclosure;

FIG. 2 is a perspective view of the piston of FIG. 1, according to the principles of the present disclosure;

FIG. 3 is two-dimensional graph illustrating a two-dimensional cross-sectional profile line of the piston bowl of the piston of FIGS. 1-2, in accordance with the principles of the present disclosure;

FIG. 4 is a cross-sectional view of a portion of the piston of FIGS. 1-2, according to the principles of the present disclosure; and

FIG. 5 is a cross-sectional view of a portion of the piston of FIGS. 1-2 and 4, taken along the line 5-5 in FIG. 4, in accordance with the principles of the present disclosure.

### DETAILED DESCRIPTION

An example of the claimed piston will now be described more fully with reference to the accompanying drawings. Numerous specific details are set forth such as examples of specific components, devices, and methods, to provide a thorough understanding of embodiments of the present disclosure. It will be apparent to those skilled in the art that specific details need not be employed, that examples may be embodied in many different forms and that neither should be construed to limit the scope of the disclosure. In some examples, well-known processes, well-known device structures, and well-known technologies are not described in detail.

The terminology used herein is for the purpose of describing particular examples only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

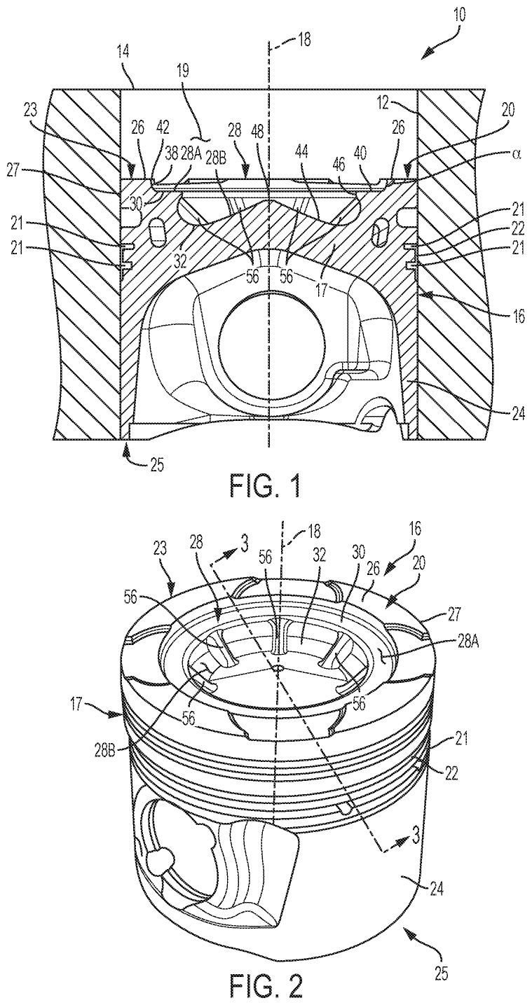

Referring to FIG. 1 of the drawings, numeral 10 generally indicates a diesel engine including a cylinder 12 having a closed upper end 14. A piston 16 is reciprocable in the cylinder 12 along a central axis 18. The piston 16 is also shown in FIG. 2. A combustion chamber 19 is formed between the piston 16 and the closed end 14 of the cylinder 12. The piston 16 generally has a cylindrical-shaped piston body 17 centered on the central axis 18. The piston body 17 includes a crown 20, a ring belt 22 with piston ring grooves 21, and a skirt 24 extending axially from the ring belt 22. The crown 20 is disposed at a distal end 23 of the piston body 17, and the skirt 24 extends from a proximal end 25 of the piston body 17.

The crown 20 has a generally planar crown surface 26 extending inward from a side wall 27 and generally defining the top of the piston 16. A stepped circular combustion bowl 28 is recessed in the crown 20 within the crown surface 26. The piston body 17 has portions 30 defining an outer combustion bowl 28A and portions 32 defining an inner combustion bowl 28B within the piston body 17 through the crown 20; thus, the combustion bowl 28 includes the outer combustion bowl 28A and the inner combustion bowl 28B.

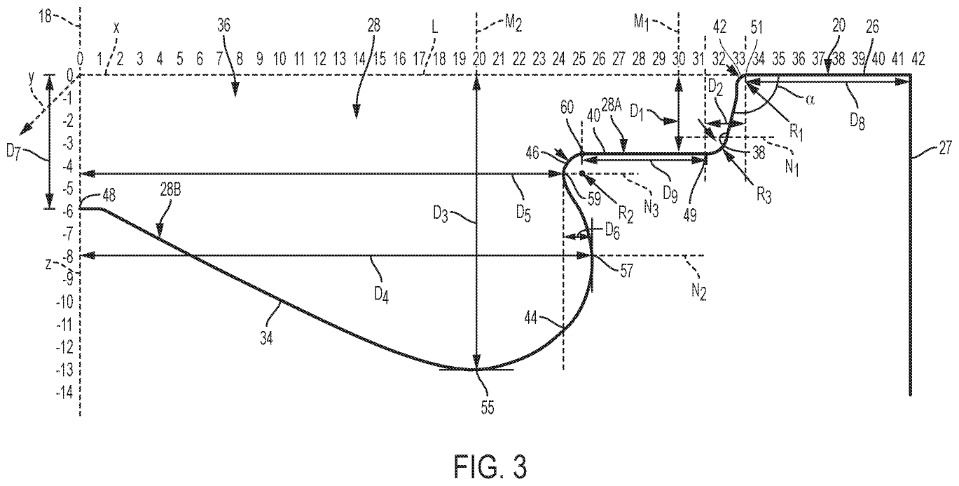

FIG. 3 shows a two-dimensional cross-sectional profile line 34 of the combustion bowl 28 on a graph 36, taken along the line 3-3 in FIG. 2. The outer wall 27 of the piston 16 is represented as shown on the graph 36, and it should be understood that the profile line 34 is a top surface of the piston body 17 defining the combustion bowl 28, including the outer bowl 28A and the inner bowl 28B. With reference to FIG. 3 and continued reference to FIGS. 1-2, the outer bowl 28A includes an upper annular side wall 38 extending from the generally planar or flat crown surface 26. The upper annular side wall 38 is angled radially inward at an angle a with respect to the crown surface 26. In some examples, the angle a can be between 100° and 110°, by way of example. For example, the angle a can be 105° or about 105°.

The outer combustion bowl 28A has an annular flat shelf 40 extending radially inward from the upper annular side wall 38. The annular flat shelf 40 is recessed a longitudinal distance D₁ from a line L that is coplanar with the crown surface 26. The longitudinal distance D₁ is measured along a line M₁ that is parallel to the central axis 18. The longitudinal distance D₁ may be in the range of 2.5 to 4.5 millimeters. For example, the longitudinal distance D₁ could be 3.5 millimeters or about 3.5 millimeters.

The upper annular side wall 38 has a slightly concave curved shape. The piston body 17 further defines in the profile line 34 an outer convex curved surface 42 connecting the upper annular side wall 38 to the crown surface 26. The outer convex curved surface 42 has a radius of curvature R₁ in the range of 0.25 to 0.75 millimeter. For example, the radius of curvature R₁ may be 0.5 millimeter or about 0.5 millimeter.

The piston body 17 defines a radius of curvature R₃ between the upper annular side wall 38 and the annular flat shelf 40. The radius of curvature R₃ could be in the range of 0.25 to 0.75 millimeter. For example, the radius of curvature R₃ could be 0.5 millimeter or about 0.5 millimeter.

The inner combustion bowl 28B is recessed relative to the annular flat shelf 40 of the outer combustion bowl 28A and has an arcuate or curved annular side wall 44 that curves radially outward from an upper edge forming a nose 46 and transitions radially inward to a mounded center 48 disposed along the central axis 18. Thus, the piston body 17 defines an annular curved inner side wall 44 forming the inner combustion bowl 28B. The piston body 17 defines an inner convex curved surface (e.g., the nose 46) connecting the annular flat shelf 40 of the outer bowl 28A to the annular curved inner side wall 44 of the inner bowl 28B. The inner convex curved surface or nose 46 has a radius of curvature R₂ in the range of 1 to 2 millimeters. For example, the radius of curvature R₂ may be 1.5 millimeters or about 1.5 millimeters.

A radial distance D₂ between the annular flat shelf 40 and the crown surface 26 is in the range of 1.5 to 2 millimeters, wherein the radial distance D₂ is measured along a line N₁ perpendicular to the central axis 18, or along any line parallel to N₁. The distance D₂ is measured from an outer end 49 of the annular flat shelf 40 to an inner end 51 of the crown surface 26. The outer end 49 of the annular flat shelf 40 is coincident with an inner end of the curved annular side wall 38, and the inner end 51 of the crown surface 26 is coincident with an outer end of the outer convex curved surface 42. In some examples, D₂ could be 1.75 millimeters, or about 1.75 millimeters.

The inner combustion bowl 28B has a lowest point 55 that is a distance D₃ from the plane L coplanar with the crown surface 26, where D₃ is measured along a line M₂ that is parallel to the central axis 18. In some examples, the distance D₃ may be 12 to 14 millimeters, and in some examples, the distance D₃ is 13.21 millimeters.

The inner combustion bowl 28B has a radially outermost point 57 that is a distance D₄ from the central axis 18 of the piston body 17, where D₄ is measured along a line N₂ that is perpendicular to the central axis 18. In some examples, the distance D₄ is in the range of 24 to 27 millimeters long. A radially innermost point 59 of the inner convex curved surface (nose 46) may be disposed a distance D₅ from the central axis 18, where D₅ is measured along a line N₃ that is perpendicular to the central axis 18. In some examples, the distance D₅ is in the range of 23 to 25 millimeters long. Thus, the radially innermost point 59 of the inner convex curved surface 46 is disposed radially inward of the radially outermost point 57 of the inner combustion bowl 28B by a radial distance D₆, where D₆ may be in the range of 1 to 2 millimeters in some examples. D₆ is measured along any line perpendicular to the central axis 18, such as N₂ or N₃ or any line parallel to N₂ and N₃.

The center 48 of the inner combustion bowl 28B is disposed a distance D₇ from the plane L that is coplanar with the crown surface 26. The center 48 is located along the central axis 18 of the piston body 17. In some examples, the distance D₇ is in the range of 5 to 7 millimeters. For example, the distance D₇ may be 5.97 millimeters.

The outer convex curved surface 42, and more specifically, the outer end of the outer convex curved surface 42 that is coincident with the inner end 51 of the crown surface 26, may be disposed a distance D₈ from the outer edge 27 of the crown 20. D₈ is measured along any line that is perpendicular to the central axis 18, such as N₁ or a line parallel to N₁. The distance D₈ may be in the range of 8 to 10 millimeters, by way of example.

The annular flat shelf 40 has a radial length D₉ extending from the upper annular side wall 38 to the inner convex curved surface (or nose 46). The radial length D₉ begins at the outer end 49 of the annular flat shelf 40 and ends at an inner end 60 of the annular flat shelf 40 (where the inner end 60 is coincident with the beginning of the nose 46). D₉ is measured along any line that is perpendicular to the central axis 18, such as N₁, N₃, or a line parallel to N₁ and N₃. In some examples, the radial length D₉ is 7 to 8 millimeters.

Except for the plurality of lips 56 extending inward from the curved side wall 44 of the inner bowl 28B (shown in FIGS. 1-2), the double bowl design 28 is axisymmetric about the center axis 18. Thus, the three-dimensional configuration of the stepped combustion bowl 28 can be obtained by rotating the cross-sectional view of FIG. 3 360 degrees about the center axis 18 and adding the lips 56. Thus, the piston body 17 ends up with a three-dimensional shape defined in an x-y-z coordinate system. The z-axis is coaxial with the central axis 18, and the x-axis is disposed in the plane L coplanar with the crown surface 26 as shown in FIG. 3. The y-axis should be understood to come out of the page of the two-dimensional x-z plane shown in FIG. 3. Thus, the plane z=0 intersects the plane L that is coplanar with the crown surface 26 at 90 degrees. The center 48 of the piston body 17 intersects the z-axis.

Thus, the combustion bowl 28 has a partial two-dimensional cross-sectional configuration defined by the peripheral line 34 connecting coordinate points (xᵢ, yᵢ, zᵢ) in the x-y-z coordinate space. The two-dimensional graph 36 in FIG. 3 is an x-z grid lying in the plane y=0 where none of the lips 56 are present in the y=0 plane because the plane y=0 is cut through the piston 16 at the line 3-3, as shown in FIG. 2. The ordinal variable “i” represents an integer between 1 and n, “n” being the total number of coordinate points along the peripheral line 34. In other words, the coordinate points along the peripheral line 34 includes points (x₁, y₁, z₁), (x₂, y₂, z₂), . . . , (xₙ, yₙ, zₙ).

The coordinate points (xᵢ, yᵢ, zᵢ) may include selected points that substantially coincide with a coordinate set S. The Coordinate Set S may include the following coordinates shown in Table 1. It should be understood that the Coordinate Set S is merely an example of the exact coordinates that may be used to form the peripheral line 34 of the combustion bowl 28. In addition, the coordinate points (xᵢ, yᵢ, zᵢ) may be carried out to a greater or lesser number of decimal points than those shown in Table 1.

The value of the coordinate points (xᵢ, yᵢ, zᵢ) represent lengths in units of millimeters. However, the coordinate points (xᵢ, yᵢ, zᵢ) may be multiplied by any factor “f” such that the resultant combustion bowl has a cross-sectional peripheral line 34 that connects coordinate points (fxᵢ, fyᵢ, fzᵢ) in the x-y-z coordinate space derived from the coordinate points (xᵢ, yᵢ, zᵢ). The factor “f” may be any real number having a value greater than zero. Multiplying the coordinate set (xᵢ, yᵢ, zᵢ) by the factor “f” results in a scaled version of the peripheral line 34 defined by the coordinate set (xᵢ, yᵢ, zᵢ). Further, minor variations due to manufacturing are within the scope of the present disclosure.

TABLE 1
Coordinate Set S.
Coordinate Set S

| i | xᵢ (mm) | yᵢ (mm) | zᵢ (mm) |
|---|---|---|---|
| 1 | 0 | 0 | −5.922 |
| 2 | 0.215 | 0 | −5.922 |
| 3 | 0.431 | 0 | −5.922 |
| 4 | 0.646 | 0 | −5.922 |
| 5 | 0.862 | 0 | −5.922 |
| 6 | 1.077 | 0 | −5.932 |
| 7 | 1.285 | 0 | −5.987 |
| 8 | 1.48 | 0 | −6.079 |
| 9 | 1.674 | 0 | −6.172 |
| 10 | 1.868 | 0 | −6.265 |
| 11 | 2.062 | 0 | −6.385 |
| 12 | 2.257 | 0 | −6.451 |
| 13 | 2.451 | 0 | −6.544 |
| 14 | 2.646 | 0 | −6.636 |
| 15 | 2.841 | 0 | −6.728 |
| 16 | 3.036 | 0 | −6.82 |
| 17 | 3.231 | 0 | −6.912 |
| 18 | 3.426 | 0 | −7.003 |
| 19 | 3.621 | 0 | −7.094 |
| 20 | 3.816 | 0 | −7.185 |
| 21 | 4.012 | 0 | −7.276 |
| 22 | 4.207 | 0 | −7.367 |
| 23 | 4.403 | 0 | −7.457 |
| 24 | 4.598 | 0 | −7.547 |
| 25 | 4.794 | 0 | −7.637 |
| 26 | 4.99 | 0 | −7.727 |
| 27 | 5.186 | 0 | −7.816 |
| 28 | 5.382 | 0 | −7.905 |
| 29 | 5.579 | 0 | −7.994 |
| 30 | 5.775 | 0 | −8.083 |
| 31 | 5.971 | 0 | −8.172 |
| 32 | 6.168 | 0 | −8.26 |
| 33 | 6.365 | 0 | −8.348 |
| 34 | 6.561 | 0 | −8.436 |
| 35 | 6.758 | 0 | −8.524 |
| 36 | 6.955 | 0 | −8.611 |
| 37 | 7.152 | 0 | −8.698 |
| 38 | 7.349 | 0 | −8.785 |
| 39 | 7.546 | 0 | −8.872 |
| 40 | 7.744 | 0 | −8.958 |
| 41 | 7.941 | 0 | −9.045 |
| 42 | 8.139 | 0 | −9.131 |
| 43 | 8.336 | 0 | −9.217 |
| 44 | 8.534 | 0 | −9.302 |
| 45 | 8.732 | 0 | −9.388 |
| 46 | 8.93 | 0 | −9.473 |
| 47 | 9.127 | 0 | −9.559 |
| 48 | 9.325 | 0 | −9.644 |
| 49 | 9.523 | 0 | −9.73 |
| 50 | 9.72 | 0 | −9.816 |
| 51 | 9.918 | 0 | −9.901 |
| 52 | 10.116 | 0 | −9.987 |
| 53 | 10.314 | 0 | −10.072 |
| 54 | 10.511 | 0 | −10.158 |
| 55 | 10.709 | 0 | −10.243 |
| 56 | 10.907 | 0 | −10.329 |
| 57 | 11.105 | 0 | −10.415 |
| 58 | 11.302 | 0 | −10.5 |
| 59 | 11.5 | 0 | −10.586 |
| 60 | 11.698 | 0 | −10.671 |
| 61 | 11.896 | 0 | −10.757 |
| 62 | 12.093 | 0 | −10.842 |
| 63 | 12.291 | 0 | −10.928 |
| 64 | 12.489 | 0 | −11.013 |
| 65 | 12.687 | 0 | −11.098 |
| 66 | 12.886 | 0 | −11.182 |
| 67 | 13.085 | 0 | −11.264 |
| 68 | 13.284 | 0 | −11.345 |
| 69 | 13.485 | 0 | −11.425 |
| 70 | 13.685 | 0 | −11.503 |
| 71 | 13.886 | 0 | −11.58 |
| 72 | 14.088 | 0 | −11.656 |
| 73 | 14.29 | 0 | −11.731 |
| 74 | 14.493 | 0 | −11.804 |
| 75 | 14.696 | 0 | −11.877 |
| 76 | 14.899 | 0 | −11.947 |
| 77 | 15.103 | 0 | −12.017 |
| 78 | 15.307 | 0 | −12.085 |
| 79 | 15.512 | 0 | −12.152 |
| 80 | 15.717 | 0 | −12.218 |
| 81 | 15.923 | 0 | −12.283 |
| 82 | 16.129 | 0 | −12.346 |
| 83 | 16.335 | 0 | −12.408 |
| 84 | 16.542 | 0 | −12.468 |
| 85 | 16.749 | 0 | −12.528 |
| 86 | 16.957 | 0 | −12.586 |
| 87 | 17.164 | 0 | −12.642 |
| 88 | 17.373 | 0 | −12.698 |
| 89 | 17.581 | 0 | −12.752 |
| 90 | 17.79 | 0 | −12.805 |
| 91 | 18 | 0 | −12.855 |
| 92 | 18.210 | 0 | −12.9 |
| 93 | 18.422 | 0 | −12.938 |
| 94 | 18.636 | 0 | −12.969 |
| 95 | 18.85 | 0 | −12.994 |
| 96 | 19.064 | 0 | −13.013 |
| 97 | 19.279 | 0 | −13.025 |
| 98 | 19.495 | 0 | −13.03 |
| 99 | 19.71 | 0 | −13.028 |
| 100 | 19.925 | 0 | −13.021 |
| 101 | 20.14 | 0 | −13.006 |
| 102 | 20.355 | 0 | −12.985 |
| 103 | 20.569 | 0 | −12.957 |
| 104 | 20.781 | 0 | −12.923 |
| 105 | 20.993 | 0 | −12.883 |
| 106 | 21.203 | 0 | −12.836 |
| 107 | 21.412 | 0 | −12.782 |
| 108 | 21.619 | 0 | −12.723 |
| 109 | 21.824 | 0 | −12.657 |
| 110 | 22.027 | 0 | −12.584 |
| 111 | 22.228 | 0 | −12.506 |
| 112 | 22.426 | 0 | −12.421 |
| 113 | 22.621 | 0 | −12.331 |
| 114 | 22.814 | 0 | −12.234 |
| 115 | 23.003 | 0 | −12.132 |
| 116 | 23.19 | 0 | −12.024 |
| 117 | 23.373 | 0 | −11.91 |
| 118 | 23.552 | 0 | −11.791 |
| 119 | 23.728 | 0 | −11.666 |
| 120 | 23.9 | 0 | −11.536 |
| 121 | 24.067 | 0 | −11.401 |
| 122 | 24.231 | 0 | −11.26 |
| 123 | 24.39 | 0 | −11.115 |
| 124 | 24.544 | 0 | −10.965 |
| 125 | 24.69 | 0 | −10.806 |
| 126 | 24.827 | 0 | −10.64 |
| 127 | 24.955 | 0 | −10.466 |
| 128 | 25.073 | 0 | −10.286 |
| 129 | 25.181 | 0 | −10.1 |
| 130 | 25.279 | 0 | −9.908 |
| 131 | 25.366 | 0 | −9.711 |
| 132 | 25.443 | 0 | −9.51 |
| 133 | 25.508 | 0 | −9.304 |
| 134 | 25.562 | 0 | −9.096 |
| 135 | 25.604 | 0 | −8.884 |
| 136 | 25.635 | 0 | −8.671 |
| 137 | 25.654 | 0 | −8.457 |
| 138 | 25.662 | 0 | −8.241 |
| 139 | 25.658 | 0 | −8.026 |
| 140 | 25.642 | 0 | −7.811 |
| 141 | 25.614 | 0 | −7.598 |
| 142 | 25.575 | 0 | −7.386 |
| 143 | 25.524 | 0 | −7.176 |
| 144 | 25.462 | 0 | −6.97 |
| 145 | 25.388 | 0 | −6.768 |
| 146 | 25.306 | 0 | −6.569 |
| 147 | 25.217 | 0 | −6.372 |
| 148 | 25.121 | 0 | −6.179 |
| 149 | 25.02 | 0 | −5.989 |
| 150 | 24.912 | 0 | −5.803 |
| 151 | 24.798 | 0 | −5.62 |
| 152 | 24.678 | 0 | −5.441 |
| 153 | 24.553 | 0 | −5.266 |
| 154 | 24.423 | 0 | −5.093 |
| 155 | 24.31 | 0 | −4.911 |
| 156 | 24.238 | 0 | −4.708 |
| 157 | 24.212 | 0 | −4.494 |
| 158 | 24.231 | 0 | −4.28 |
| 159 | 24.296 | 0 | −4.075 |
| 160 | 24.403 | 0 | −3.889 |
| 161 | 24.548 | 0 | −3.73 |
| 162 | 24.723 | 0 | −3.605 |
| 163 | 24.921 | 0 | −3.521 |
| 164 | 25.132 | 0 | −3.481 |
| 165 | 25.348 | 0 | −3.478 |
| 166 | 25.563 | 0 | −3.478 |
| 167 | 25.779 | 0 | −3.478 |
| 168 | 25.994 | 0 | −3.478 |
| 169 | 26.21 | 0 | −3.478 |
| 170 | 26.425 | 0 | −3.478 |
| 171 | 26.641 | 0 | −3.478 |
| 172 | 26.856 | 0 | −3.478 |
| 173 | 27.071 | 0 | −3.478 |
| 174 | 27.287 | 0 | −3.478 |
| 175 | 27.502 | 0 | −3.478 |
| 176 | 27.718 | 0 | −3.478 |
| 177 | 27.933 | 0 | −3.478 |
| 178 | 28.149 | 0 | −3.478 |
| 179 | 28.364 | 0 | −3.478 |
| 180 | 28.58 | 0 | −3.478 |
| 181 | 28.795 | 0 | −3.478 |
| 182 | 29.011 | 0 | −3.478 |
| 183 | 29.226 | 0 | −3.478 |
| 184 | 29.442 | 0 | −3.478 |
| 185 | 29.657 | 0 | −3.478 |
| 186 | 29.872 | 0 | −3.478 |
| 187 | 30.088 | 0 | −3.478 |
| 188 | 30.303 | 0 | −3.478 |
| 189 | 30.519 | 0 | −3.478 |
| 190 | 30.734 | 0 | −3.478 |
| 191 | 30.95 | 0 | −3.478 |
| 192 | 31.165 | 0 | −3.478 |
| 193 | 31.381 | 0 | −3.478 |
| 194 | 31.596 | 0 | −3.468 |
| 195 | 31.804 | 0 | −3.414 |
| 196 | 31.996 | 0 | −3.318 |
| 197 | 32.163 | 0 | −3.182 |
| 198 | 32.297 | 0 | −3.014 |
| 199 | 32.392 | 0 | −2.821 |
| 200 | 32.451 | 0 | −2.614 |
| 201 | 32.507 | 0 | −2.406 |
| 202 | 32.563 | 0 | −2.198 |
| 203 | 32.619 | 0 | −1.99 |
| 204 | 32.675 | 0 | −1.781 |
| 205 | 32.73 | 0 | −1.573 |
| 206 | 32.786 | 0 | −1.365 |
| 207 | 32.842 | 0 | −1.157 |
| 208 | 32.898 | 0 | −0.949 |
| 209 | 32.9 | 0 | −0.734 |
| 210 | 32.9 | 0 | −0.518 |
| 211 | 32.9 | 0 | −0.303 |
| 212 | 32.9 | 0 | −0.087 |
| 213 | 33.028 | 0 | 0 |
| 214 | 33.243 | 0 | 0 |
| 215 | 33.459 | 0 | 0 |
| 216 | 33.674 | 0 | 0 |
| 217 | 33.89 | 0 | 0 |
| 218 | 34.105 | 0 | 0 |
| 219 | 34.321 | 0 | 0 |
| 220 | 34.536 | 0 | 0 |
| 221 | 34.752 | 0 | 0 |
| 222 | 34.967 | 0 | 0 |
| 223 | 35.183 | 0 | 0 |
| 224 | 35.398 | 0 | 0 |
| 225 | 35.614 | 0 | 0 |
| 226 | 35.829 | 0 | 0 |
| 227 | 36.044 | 0 | 0 |
| 228 | 36.26 | 0 | 0 |
| 229 | 36.475 | 0 | 0 |
| 230 | 36.691 | 0 | 0 |
| 231 | 36.906 | 0 | 0 |
| 232 | 37.122 | 0 | 0 |
| 233 | 37.337 | 0 | 0 |
| 234 | 37.553 | 0 | 0 |
| 235 | 37.768 | 0 | 0 |
| 236 | 37.984 | 0 | 0 |
| 237 | 38.199 | 0 | 0 |
| 238 | 38.414 | 0 | 0 |
| 239 | 38.63 | 0 | 0 |
| 240 | 38.845 | 0 | 0 |
| 241 | 39.061 | 0 | 0 |
| 242 | 39.276 | 0 | 0 |
| 243 | 39.492 | 0 | 0 |
| 244 | 39.707 | 0 | 0 |
| 245 | 39.923 | 0 | 0 |
| 246 | 40.138 | 0 | 0 |
| 247 | 40.354 | 0 | 0 |
| 248 | 40.569 | 0 | 0 |
| 249 | 40.785 | 0 | 0 |
| 250 | 41 | 0 | 0 |

It should also be understood that, in some examples, the peripheral line 34 may be defined by fewer than all of the coordinates from the Coordinate Set S, such that only a subset of the Coordinate Set S is used to define the peripheral line 34. In one example, the peripheral line 34 is defined by the subset Sa of the Coordinate Set S. The subset Sa may include other coordinate points in addition to those shown in the subset Sa, which may include other coordinates from the Coordinate Set S, or other coordinates that are not part of the Coordinate Set S. The Coordinate Subset Sa is shown in Table 2.

TABLE 2
Coordinate Subset Sa.
Coordinate Set Sa

| i | xᵢ (mm) | yᵢ (mm) | zᵢ (mm) |
|---|---|---|---|
| 147 | 25.217 | 0 | −6.372 |
| 154 | 24.423 | 0 | −5.093 |
| 157 | 24.212 | 0 | −4.494 |
| 160 | 24.403 | 0 | −3.889 |
| 165 | 25.348 | 0 | −3.478 |
| 193 | 31.381 | 0 | −3.478 |
| 197 | 32.163 | 0 | −3.182 |
| 202 | 32.563 | 0 | −2.198 |
| 208 | 32.898 | 0 | −0.949 |
| 212 | 32.9 | 0 | −0.087 |
| 213 | 33.028 | 0 | 0 |

Additional subsets may be used to further define the peripheral line 34, such as Coordinate Subset Sb, which is shown in Table 3.

TABLE 3
Coordinate Subset Sb.
Coordinate Set Sb

| i | xᵢ (mm) | yᵢ (mm) | zᵢ (mm) |
|---|---|---|---|
| 1 | 0 | 0 | −5.922 |
| 6 | 1.077 | 0 | −5.932 |
| 8 | 1.480 | 0 | −6.079 |
| 80 | 15.717 | 0 | −12.218 |
| 89 | 17.581 | 0 | −12.752 |
| 93 | 18.422 | 0 | −12.938 |
| 98 | 19.495 | 0 | −13.03 |
| 103 | 20.569 | 0 | −12.957 |
| 111 | 22.228 | 0 | −12.506 |
| 120 | 23.9 | 0 | −11.536 |
| 129 | 25.181 | 0 | −10.1 |
| 138 | 25.662 | 0 | −8.241 |

Coordinate Subset Sa, shown in Table 2, only describes coordinate points in the upper bowl 28A and the step up to the crown 20. Coordinate Subset Sb, shown in Table 3, includes some coordinate points from the lower bowl 28B. Coordinate Set S, shown in Table 1, includes Subsets Sa and Sb and additional coordinates along the half piston.

Referring to FIG. 2, the crown 20 of the piston 16 can further include a plurality of radially outwardly extending reliefs 50 formed through the crown surface 26. The reliefs 50 can be equally spaced and have side walls 52 that narrow the reliefs 50 as the reliefs 50 extend radially outward. The fuel sprayed from a fuel injector (not shown) is sprayed from the central axis 18 out toward the annular outer wall 44 of the inner combustion bowl 28B.

As stated in brief above, a plurality of protruding lips 56 extends from the curved annular side wall 44 of the inner combustion bowl 28B toward the central axis 18. Preferably, each protruding lip 56 is equally spaced about the central axis 18, such that each protruding lip 56 is spaced an equal distance from adjacent protruding lips. Any desired number of protruding lips 56 may be included, such as seven, eight, nine, or ten protruding lips 56, by way of example. Therefore, if the protruding lips 56 are equally spaced from each other and eight protruding lips 56 are included, each protruding lip 56 would be spaced at a 45-degree sector about the central axis 18; if the protruding lips 56 are equally spaced from each other and nine protruding lips 56 are included, each protruding lip 56 would be spaced at a 40-degree sector about the central axis 18; and if the protruding lips 56 are equally spaced from each other and ten protruding lips 56 are included, each protruding lip 56 would be spaced at a 36-degree sector about the central axis 18. In some examples, the number of protruding lips 56 may be equal to, or correspond to, the number of spray holes in the accompanying fuel injector.

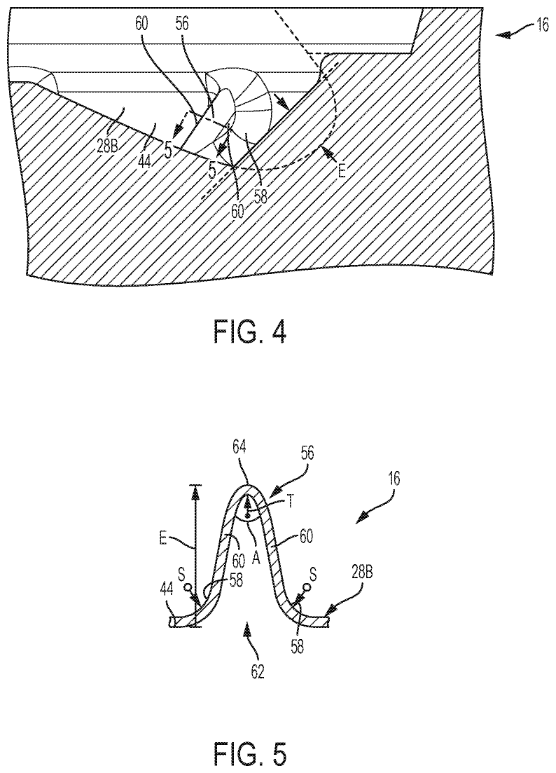

Referring now to FIGS. 4 and 5, with continued reference to FIG. 2, in some examples, each protruding lip 56 has a height E between 2.5 and 5.5 millimeters, wherein the height E extends from the base 62 of the protruding lip 56 along the curved annular side wall 44 of the inner combustion bowl 28B to a distal end 64 of the protruding lip 56. In other words, each protruding lip 56 extends a distance E from the curved annular side wall 44, and each protruding lip 56 extends along its height E from the curved annular side wall 44. In some examples the height E may be in the range of 3 to 5 millimeters.

The protruding lips 56 may intersect the curved annular side wall 44 at fillets 58. Each fillet 58 may having a fillet radius S in the range of 0.75 to 3.25 millimeters. In some examples, the fillet radius S may be 1-3 millimeters. Each protruding lip 56 has a pair of lip side walls 60 that form the lip 56. The lip side walls 60 extend from the curved annular side wall 44 of the inner combustion bowl 28B and meet at the distal end 64. Each pair of lip side walls 60 define an angle A therebetween. Preferably, the angle A is ten degrees or less. Further, a radius of curvature T at the angle A between the lip side walls 60 may be in the range of 1 to 3 millimeters, by way of example.

The improved design of the sharp step combustion bowl 28 achieves simultaneous reduction of soot and NOₓ emissions by providing enhanced mixing of combustion products with excess air available in the cylinder 12. Further, the combustion bowl 28 achieves this reduction of soot and NOₓ emissions while also maintaining or improving fuel consumption using conventional fuel injection and air handling equipment. The reduction of soot further achieves the benefit of keeping the engine oil cleaner. Moreover, the combustion bowl 28 may potentially increase power density through the reduction of soot emissions, thereby allowing for higher fueling rates while still meeting governmentally mandated soot emission levels. The upper annular side wall 38 of the outer combustion bowl 28A limits excessive spray penetration at high loads. In addition, at high loads, the protruding radial lips 56 provide separate to the spray combustion to cause avoidance of over-rich production and therefore lower the production of particulate matter. At low loads, the protruding radial lips 56 reduce heat loss by lowering air motions.

The foregoing description has been provided for purposes of illustration and description. It is not intended to be exhaustive or to limit the disclosure. Individual elements or features of a particular example are generally not limited to that example, but, where applicable, are interchangeable and can be used in another example, even if not specifically shown or described. The same may also be varied in many ways. Such variations are not to be regarded as a departure from the disclosure, and all such modifications are intended to be included within the scope of the disclosure.

What is claimed is:

1. A piston for a diesel engine, comprising:
a piston body having a skirt extending from a proximal end of the piston body; and
a crown disposed at a distal end of the piston body and defining a crown surface, the piston body having portions defining an outer combustion bowl and an inner combustion bowl within the piston body through the crown, the outer combustion bowl having an upper annular side wall extending from the crown surface and an annular flat shelf extending from the upper annular side wall, the inner combustion bowl being recessed with respect to the annular flat shelf of the outer combustion bowl, the inner combustion bowl having a curved annular side wall and a plurality of protruding lips extending from the curved annular side wall toward a central axis of the piston body.

2. The piston of claim 1, each protruding lip of the plurality of protruding lips being equally spaced about the central axis.

3. The piston of claim 2, each protruding lip of the plurality of protruding lips having a height between 2.5 and 5.5 millimeters, the height extending from a base of a protruding lip along the curved annular side wall to a distal end of the respective protruding lip.

4. The piston of claim 3, wherein the plurality of protruding lips includes at least seven protruding lips and fewer than eleven protruding lips.

5. The piston of claim 3, each protruding lip of the plurality of protruding lips intersecting the curved annular side wall at a fillet, each fillet having a fillet radius in the range of 0.75 to 3.25 millimeters.

6. The piston of claim 5, wherein each protruding lip of the plurality of protruding lips has a pair of lip side walls extending from the curved annular side wall, each pair of lip side walls defining an angle therebetween, the angle being ten degrees or less.

7. The piston of claim 6, the annular flat shelf being recessed a longitudinal distance in the range of 2.5 to 4.5 millimeters from a plane coplanar with the crown surface, the longitudinal distance being measured along a first line parallel to the central axis.

8. The piston of claim 7, the piston body defining an inner convex curved surface connecting the annular flat shelf of the outer combustion bowl to the curved annular side wall of the inner combustion bowl.

9. The piston of claim 8, the inner convex curved surface having a radius of curvature in the range of 1 to 2 millimeters.

10. The piston of claim 9, a first radial distance between the annular flat shelf and the crown surface being in the range of 1.5 to 2 millimeters, the first radial distance being measured along a first line perpendicular to the central axis.

11. The piston of claim 10, a radius of curvature between the upper annular side wall and the annular flat shelf being in the range of 0.25 to 0.75 millimeter.

12. The piston of claim 11, the inner combustion bowl having a lowest point that is 12 to 14 millimeters from the plane coplanar with the crown surface along a second line parallel to the central axis, the inner combustion bowl having a radially outermost point that is 24 to 27 millimeters from the central axis along a second line perpendicular to the central axis.

13. The piston of claim 12, a center of the inner combustion bowl being disposed 5 to 7 millimeters from the plane coplanar with the crown surface along the central axis, the center being located along the central axis of the piston body.

14. The piston of claim 13, a radially innermost point of the inner convex curved surface being disposed 23 to 25 millimeters from the central axis along a third line perpendicular to the central axis.

15. The piston of claim 14, the radially innermost point of the inner convex curved surface being disposed radially inward of the radially outermost point of the inner combustion bowl by a second radial distance of 1 to 2 millimeters, the second radial distance being measured along a fourth line perpendicular to the central axis.

16. The piston of claim 15, the piston body defining an outer convex curved surface connecting the upper annular side wall to the crown surface, the outer convex curved surface having a radius of curvature in the range of 0.25 to 0.75 millimeter.

17. The piston of claim 16, the outer convex curved surface being disposed 8 to 10 millimeters from an outer edge of the crown along a fifth line perpendicular to the central axis.

18. The piston of claim 17, the annular flat shelf having a radial length extending from the upper annular side wall to the inner convex curved surface, the radial length being 7 to 8 millimeters.

19. The piston of claim 18, the upper annular side wall extending from the crown surface at an angle between 100 and 110 degrees.

20. The piston of claim 19, the crown surface defining a plurality of radially outwardly extending reliefs formed through the crown surface, each relief being defined by a pair of relief side walls that narrow the reliefs as the reliefs extend radially outward.
